(19) United States
(12) Patent Application Publication
(10) Pub. No.: US 2021/0395445 A1
(43) Pub. Date: Dec. 23, 2021

(54) Heat and Aging Resistant Polyglycolide Copolymer and Composition Thereof

(71) Applicant: Pujing Chemical Industry Co., Ltd., Shanghai (CN)

(72) Inventor: Xinzhou ZHANG, Shanghai (CN)

(21) Appl. No.: 17/289,381

(22) PCT Filed: Oct. 29, 2018
(86) PCT No.: PCT/CN2018/112428

§ 371 Date: Apr. 28, 2021

(51) Int. Cl. C08G 63/08; C08K 5/00; C08G 63/78; C08K 3/013

(52) U.S. Cl. CPC C08G 63/08; C08K 3/013; C08G 63/78; C08K 5/0041

(57) ABSTRACT

The invention relates novel polyglycolide copolymers comprising a colorant. The copolymers may have a weight-average molecular weight (Mw) in the range of 10,000-1,000,000, a ratio of a weight-average molecular weight to a number-average molecular weight (Mw/Mn) in the range of 1.0 to 4.0, and a yellowness index (YI) is the range of 40-90. The copolymers may have a melt index (MFR) in the range of 0.1 to 1000 g/10 min. The copolymers may have a stable yellowness index, good thermal stability and aging resistance. Also provided are a process for preparing the copolymers and a method for reducing yellowness index change rate of a polyglycolide copolymer.

### FIELD OF THE INVENTION

The invention provides a novel degradable copolymer having good thermal stability and aging resistance and preparation thereof.

### BACKGROUND OF THE INVENTION

Polyglycolide, also known as poly(glycolic acid) (PGA), and its copolymer are new type of degradable materials with excellent mechanical strength and biocompatibility. They have been widely used in medical implants such as sutures and stents in biomedical engineering. In recent years, with the continuous development of these materials, and due to their excellent processing and mechanical properties, their application have been expanded to fibers, downhole tools, packaging, film, pharmaceutical drug carriers, abrasives, cosmetics, underwater antifouling materials, etc.

Various artificial colorants are used in manufacturing products, and measurement and inspection of their color index values have become the key to quality control and product inspection in various industries. For example, among inorganic non-metallic materials, colored cement, colored glass products, colored ceramic products, etc., all involve color measurement. With the increasing time of use, color change of a product itself is also one of the key factors that affecting product quality. Products with smaller changes in color values are advantageous in winning the market. In addition, measurement of change of color and color value is needed in textile, printing and dyeing, paper, chemical, food and other industries. In the case of polyglycolide and its copolymer, they have a certain dark yellow color. After these materials are used for a period of time, their color changes greatly due to exposure to light or heat, which affects usage experience. This is a major drawback of the use of polyglycolide and its copolymers. At the same time, since polyglycolide exhibits hydrolyzability, it is more susceptible to hydrolytic age at high temperatures than other polyesters alone as molding materials, affecting its own material processing and properties.

CN100413906C discloses a polyglycolic acid obtained by ring opening polymerization of glycolide. The sheet generated by crystallization and hot pressing of polyglycolic acid has a maximum yellowness index of 40. It has been discovered that such material is highly degradable during aging at a high temperature, and the yellowness index changes greatly, which affects the processability of the material and the practical applicability of the final material.

CN101484528 discloses another aliphatic polyester mixture containing polyglycolic acid which improves crystallization and processability, but does not improve heat degradation and color value change at high temperatures. From the currently reported technology, polyglycolide and its copolymers can rarely maintain stable color values and resistance to thermal aging at high temperatures simultaneously.

There remains a need for a degradable copolymer having good thermal stability and aging resistance.

### SUMMARY OF THE INVENTION

The present invention provides polyglycolide copolymers and preparation thereof.

A copolymer is provided. The copolymer comprises one or more repeating units of C-(Aₓ-B_{y})ₙ-D and a colorant. A is

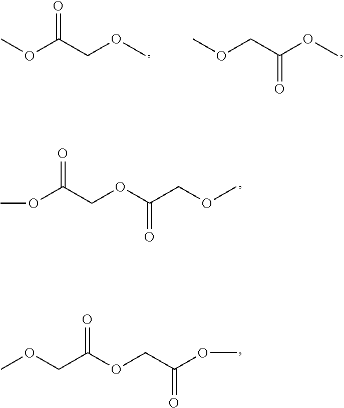

or a combination thereof. B is G-R₁—W. G and W are each selected from the group consisting of —CO—NH—, —CO—R₂—CO—OH, —CO—, —(CH₂)₂NH—CO—, —CH₂—CH(OH)—CH₂— and —NH. R₁ is an aliphatic polymer, an aromatic polymer or a combination thereof. R₂ is an alkyl group, an aromatic group, or an olefin group. x is between 1 and 1500. y is between 1 and 1500. n is between 1 and 10000. C and D are each a terminal group selected from the group consisting of a hydroxyl group, a carboxyl group, an amine group, an alkyl group, an aromatic group, an ether group, an alkene group, a halogenated hydrocarbon group and a combination thereof. A and B are different in structure.

The copolymer may further comprise an additive. The additive may be selected from the group consisting of E, F or a combination thereof.

E may be one or more of units of i-R₁-j. i and j may be each selected from the group consisting of an isocyanate group (—N═C═O), an acid chloride group, an oxazolyl group, an oxazoline group, an anhydride, an epoxy group, an amine group and a combination thereof. R₁ may be an aliphatic group, an aromatic group, or a combination thereof.

F may be selected from the group consisting of an antioxidant, a metal passivator, an end-capping agent, a nucleating agent, an acid scavenger, a heat stabilizer, a UV stabilizer, a lubricant plasticizer, a crosslinking agent, and a combination thereof.

A process for preparing a copolymer is provided. The process comprises ring-opening polymerizing glycolide in a molten state, whereby a polyglycolide is formed; and extruding and granulating the polyglycolide and a colorant to prepare a copolymer. The copolymer comprises one or more repeating units of C-(Aₓ-B_{y})ₙ-D. A is

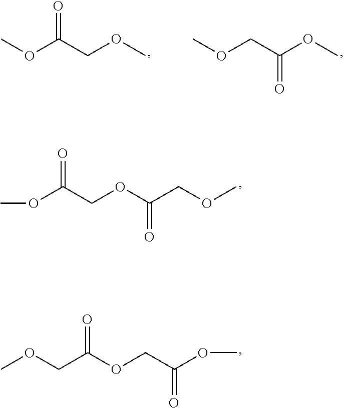

or a combination thereof. B is G-R₁—W. G and W are each selected from the group consisting of —CO—NH—, —CO—R₂—CO—OH, —CO—, —(CH₂)₂NH—CO—, —CH₂—CH(OH)—CH₂— and —NH. R₁ is an aliphatic polymer, an aromatic polymer or a combination thereof. R₂ is an alkyl group, an aromatic group, or an olefin group. x is between 1 and 1500. y is between 1 and 1500. n is between 1 and 10000. C and D are each a terminal group selected from the group consisting of a hydroxyl group, a carboxyl group, an amine group, an alkyl group, an aromatic group, an ether group, an alkene group, a halogenated hydrocarbon group and a combination thereof. A and B are different in structure.

The polyglycolide may be extruded and granulated with an additive selected from the group consisting of E, F or a combination thereof. E is one or more of units of i-R₁-j. i and j may be each selected from the group consisting of an isocyanate group (—N═C═O), an acid chloride group, an oxazolyl group, an oxazoline group, an anhydride, an epoxy group, an amine group and a combination thereof. R₁ is an aliphatic group, an aromatic group, or a combination thereof. F is selected from the group consisting of an antioxidant, a metal passivator, an end-capping agent, a nucleating agent, an acid scavenger, a heat stabilizer, a UV stabilizer, a lubricant plasticizer, a crosslinking agent, and a combination thereof.

The process may further comprise feeding the polyglycolide and the colorant into an extruder, and adding the E and the F into the extruder.

The ring-opening polymerization of glycolide may be a three-stage reaction, comprising: (a) reacting the glycolide with a ring-opening polymerization catalyst at 80-160° C. for no more than 120 minutes, wherein a first mixture is formed; (b) maintaining the first mixture at 120-280° C. for a time from 1 minute to 72 hours, whereby a second mixture is formed; (c) maintaining the second mixture at 160-280° C. and an absolute pressure no more than 5000 Pa for a time from 1 minute to 24 hours. As a result, the polyglycolide is formed. Step (a) may further comprise mixing the glycolide with the ring-opening polymerization catalyst uniformly. Step (a) may be carried out in a reactor. Step (b) may be carried out in a plug flow reactor. The plug flow reactor may be selected from the group consisting of a static mixer, a twin-screw unit and a horizontal disk reactor. Step (c) may be carried out in a devolatilization reactor. Step (b) may be carried out in a twin-screw extruder at 200-300° C.

The ring-opening polymerization catalyst may be a metal catalyst or a non-metal catalyst. The catalyst may be selected from the group consisting of a rare earth element, a rare earth element oxide, a metal magnesium compound, an alkali metal chelate compound (e.g., tin, antimony, or titanium), a metal ruthenium and a combination thereof. The catalyst may be 0.01-5 wt % of the glycolide.

A copolymer prepared according to the process of the present invention is provided.

The copolymer of the present invention may comprise an additive at 0.01-5 wt %, based on the total weight of the copolymer. The additive may be selected from the group consisting of E, F or a combination thereof.

The copolymer may have a weight-average molecular weight of 10,000-1,000,000. The copolymer may have a ratio of a weight-average molecular weight to a number-average molecular weight (Mw/Mn) of 1.0-4.0.

The copolymer may have a melt index (MFR) of 0.1-1000 g/10 min. The MFR may be determined according to a method comprising: (a) drying the copolymer under vacuum at 100-110° C.; (b) packing the dried copolymer from step (a) into a rod; (c) keeping the rod at 220-240° C. for 0.5-1.5 minutes; (d) cutting a segment from the rod every 15-45 seconds after step (c); and (e) determining a MFR of each segment based on MFR=600 W/t(g/10 min). W is the average mass of each segment and t is the cutting time gap for each segment. Step (b) may further comprise loading 3-5 g of the dried copolymer into a barrel, inserting a plunger into the barrel to compact the dried copolymer into the rod, and placing a weight of 2-3 kg on the top of the plunger.

The copolymer may comprise the colorant at 0.001-30.000 wt %. The colorant may be an inorganic compound, an organic compound, or a combination thereof. The colorant may be a pigment, a dye or a combination thereof. The pigment may be selected from the group consisting of an inorganic pigment, a phthalocyanine pigment, a heterocyclic and anthraniloid pigment, an oxonium lake pigment, a triarylmethane pigment, a triarylmethane lake pigment, a nitro pigment, a nitroso pigment, an imine pigment, a methylimine metal complex pigment, a fluorescent pigment, a monoazo pigment, a disazo pigment, a benzimidazolone pigment, a bisacetylacetoacetylamine pigment, an isoporphyrin pigment, a quinoxalinedione pigment, a diamine pigment, a quinone pyrimidine pigment, a titanium oxide, a titanium salt, an iron oxide, an iron salt, a molybdenum oxide, a molybdenum salt and a combination thereof. The dye may be selected from the group consisting of an acid dye, an ice dye, a cationic dye, a direct dye, a disperse dye, a reactive dye, a sulfur dye, a vat dye, a solvent dye and a combination thereof.

The colorant may comprise a yellow colorant. The yellow colorant may be selected from the group consist of P.Y.129, C.I. Pigment Yellow 7, C.I. Pigment Yellow 12, C.I. Pigment Yellow 13, C.I. Pigment Yellow 14, C.I. Pigment Yellow 17, C.I. Pigment Yellow 93, C.I. Pigment Yellow 120, C.I. Pigment Yellow 128, C.I. Pigment Yellow 138, C.I. Pigment Yellow 139, C.I. Pigment Yellow 151, C.I. Pigment Yellow 154, C.I. Pigment Yellow 155, C.I. Pigment Yellow 174, C.I. Pigment Yellow 180, C.I. Pigment Yellow 185, C.I. Pigment Yellow 194, C.I. Pigment Yellow 194, C.I. Pigment Yellow 198, C.I. Pigment Yellow 213, C.I. Pigment Yellow 214, C.I. Pigment Yellow 217, Solvent Yellow 33, Solvent Yellow 43, Solvent Yellow 44, Solvent Yellow 85, Solvent Yellow 98, Solvent Yellow 104, Solvent Yellow 116, Solvent Yellow 131, Solvent Yellow 135, Solvent Yellow 145, Solvent Yellow 160:1, Solvent Yellow 172, C.I. coumarin 6, P.Y.129 and Basic Yellow. The colorant may further comprise another colorant such as a red colorant, green colorant, an orange colorant or a combination thereof. The copolymer may have a yellowness index (YI) of 40-90 when measured using a sheet obtained by compression molding and crystallization of the copolymer. The copolymer may have a yellowness index change rate (ΔYI=(YI after aging−YI before aging)*100%/YI before aging) is less than 300% after heat aging at 150° C. for 72 hours.

The copolymer may comprise a metal passivator no more than 1% of the copolymer. The metal passivator may be selected from the group consisting of an oxalate derivative, an anthraquinone compound, a salicylic acid derivative, a benzotriazole compound, and an anthraquinone compound.

A method for reducing yellowness index change rate of a polyglycolide copolymer is provided. The method comprises adding an effective amount of a yellow colorant into the polyglycolide copolymer. The yellowness index change rate may be reduced by at least 10%, 20%, 30%, 40%, 50%, 60%, 70%, 80%, 90% or 95%. The polyglycolide copolymer may be one of the copolymers of the invention.

### DETAILED DESCRIPTION OF THE INVENTION

The invention provides novel degradable material polyglycolide copolymers and preparation thereof. This invention is based on the inventors' surprising discovery of a novel process for preparing polyglycolide copolymers with one or more additive to improve their thermal stability, MFR retention rate and yellowness index change after aging. The polyglycolide copolymers of the present invention are suitable for diverse uses, for example, fibers, downhole tools, packaging, films, pharmaceutical carriers, medical implantable devices, abrasives, cosmetics, underwater antifouling materials, etc.

The terms “polyglycolide”, “poly(glycolic acid) (PGA)” and “polyglycolic acid” are used herein interchangeably and refer to a biodegradable, thermoplastic polymer composed of monomer glycolic acid. A polyglycolide may be prepared from glycolic acid by polycondensation or glycolide by ring-opening polymerization. An additive may be added to the polyglycolide to achieve a desirable property.

The term “polyglycolide copolymer” is a polymer derived from a glycolide or glycolic acid monomer and a different polymer monomer. For example, a polyglycolide copolymer may be prepared with a polyglycolide and ADR4368 by extrusion,

A copolymer is provided. The copolymer comprises one or more repeating units of C-(Aₓ-B_{y})ₙ-D. A is selected from the group consisting of

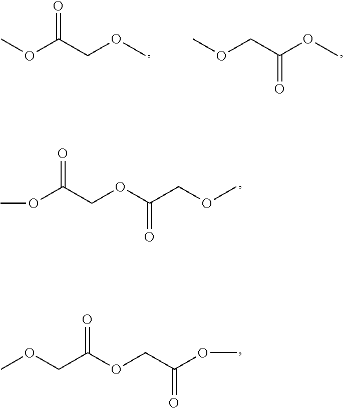

and a combination thereof. B is G-R₁—W, in which G and W are each selected from the group consisting of —CO—NH—, —CO—R₂—CO—OH, —CO—, —(CH₂)₂NH—CO—, —CH₂—CH(OH)—CH₂— and —NH; R₁ is an aliphatic polymer, an aromatic polymer or a combination thereof; and R₂ is an alkyl group, an aromatic group, or an olefin group. x is between 1 and 1500. y is between 1 and 1500. n is between 1 and 10000. C and D are each a terminal group selected from the group consisting of a hydroxyl group, a carboxyl group, an amine group, an alkyl group, an aromatic group, an ether group, an alkene group, a halogenated hydrocarbon group and a combination thereof. A and B are different in structure.

The copolymer may further comprise E. E may be one or more of units of i-R₁-j. i and j are each selected from the group consisting of an isocyanate group (—N═C═O), an acid chloride group, an oxazolyl group, an oxazoline group, an anhydride, an epoxy group, an amine group and a combination thereof. R₁ may be an aliphatic group, an aromatic group, or a combination thereof.

The copolymer may further comprise F. F may be selected from the group consisting of an antioxidant, a metal passivator, an end-capping agent, a nucleating agent, an acid scavenger, a heat stabilizer, a UV stabilizer, a lubricant plasticizer, a crosslinking agent, and a combination thereof.

An antioxidant may be selected from the group consisting of BASF Irganox 168, 101, 245, 1024, 1076, 1098, 3114, MD 1024, 1025, ADEKA AO-60, 80, STAB PEP-36, 8T, Albemarle AT-10, 245, 330, 626, 702, 733, 816, 1135 a combination thereof.

The copolymer may comprise a metal passivator no more than about 0.5 wt %, 1 wt % or 2 wt % of the copolymer. The metal passivator may be selected from the group consisting of BASF Chel-180, Eastman OABH, Naugard XL-1, MD24, ADEKA STAB CDA-1, 6, oxalic acid derivatives, hydrazines, salicylic acid derivatives, benzotriazole and guanidine compounds, and a combination thereof.

An end capping agent may be monofunctional organic alcohol, acid, amine or ester. The end capping agent may also be an isocynate, siloxane, isocyanate, chloride group, oxazolyl compound, oxazoline compound, anhydride compound or epoxy compound.

A nucleating agent may be inorganic salt or organic salt, talc, calcium oxide, carbon black, calcium carbonate, mica, sodium succinate, glutarate, sodium hexanoate, sodium 4-methylvalerate, adipates, aluminum p-tert-butylbenzoate (AI-PTB-BA), metal carboxylates (e.g., potassium benzoate, lithium benzoate, sodium cinnamate, sodium β-naphthoate), dibenzylidene sorbitol (DBS) derivatives(di(p-methylbenzylidene) sorbitol(P-M-DBS), di(p-chlorobenzylidene) sorbitol (P-CI-DBS)). Commercial examples include SURLYN 9020, SURLYN1601, SURLYN1605, SURLYN1650, SURLYN1652, SURLYN1702, SURLYN1705, SURLYN8920, SURLYN8940, SURLYNPC-350 and SURLYNPC-2000.

An acid scavenger may be metal stearate or lactate such as calcium stearate or calcium lactate, or an inorganic substance such as hydrotalcite, zinc oxide, magnesium oxide or aluminum oxide.

A heat stabilizer may be an amine compound, phenol compound, thioester compound, phosphite compound or benzofuraone compound. The heat stabilizer may also be a lead salt heat stabilizer (e.g., tribasic lead sulfate, dibasic lead phosphite, dibasic lead stearate or basic lead carbonate), a metal soap heat stabilizer (e.g., zinc stearate, stearic acid, calcium or magnesium stearate), an organotin heat stabilizer (e.g., sulfur-containing organotins or organotin carboxylates) or a rare earth heat stabilizer.

A UV stabilizer may be a triazine compound, benzotriazole compound, benzophenone compound, salicylic acid ester compound or acrylonitrile compound. Examples of UV stabilizers include:

UV 944, CAS #:70624-18-9, Poly[[6-[(1,1,3,3-tetramethylbutyl)amino]-1,3,5-triazine-2,4-diyl][(2,2,6,6-tetramethyl-4-piperidinyl)imino]-1,6-hexanediyl[(2,2,6,6-tetramethyl-4-piperidinyl)imino]],

UV770, CAS #52829-07-9, Bis(2,2,6,6,-tetramethyl-4-piperidyl)sebaceate,

UV622, CAS #65447-77-0, Butanedioic acid, dimethylester, polymer with 4-hydroxy-2,2,6,6-tetramethyl-1-piperidine ethanol,

UV783, a half-half mixture of UV622 and UV944,

UV531, CAS #1843-05-6, 2-benzoyl-5-(octyloxy) phenol,

UV326, CAS #3896-11-5, 2-(2′-Hydroxy-3′-t-butyl-5′-methylphenyl)-5-chlorobenzotriazole,

UV327, CAS #3864-99-1, 2-(2′-Hydroxy-3′, 5′-di-tert-butylphenyl)-5-chlorobenzotriazole,

UV292, a mixture of Bis(1,2,2,6,6-pentamethyl-4-piperidinyl)sebacate, CAS #41556-26-7 (75-85%) and Methyl(1,2,2,6,6-pentamethyl-4-piperidinyl)sebacate, CAS #82919-37-7 (15-25%) and,

UV123 CAS #129757-67-1, Bis(1-octyloxy-2,2,6,6-tetramethyl-4-piperidyl)sebacate.

A lubricant plasticizer may be a saturated hydrocarbon (e.g., solid paraffin, liquid paraffin, microcrystalline paraffin or low molecular weight polyethylene), a metal stearate (e.g., zinc stearate, calcium stearate or magnesium stearate), an aliphatic amide (e.g., ethylene bis stearamide (EBS) or oleamide), a fatty acid (e.g., stearic acid or hydroxystearic acid), a fatty acid ester (e.g., pentaerythrityl tetrastearate (PETS), glyceryl monostearate or glyceryl polystearate) and a fatty alcohol (e.g., stearyl alcohol or pentaerythritol).

A crosslinking agent may be selected from the group consisting of isocyanates (e.g., emulsifiable methylene diphenyl diisocyanate (MDI), tetraisocyanate, triisocyanate, polyisocyanate (e.g., Leiknonat JQ glue series, and Desmodur L series)), acrylates (e.g., 1,4-butanediol diacrylate, ethylene glycol dimethacrylate and butyl acrylate), organic peroxides (e.g., dicumyl peroxide, benzoyl peroxide, and di-tert-butyl peroxide), polyols, polybasic acids or polyamines (e.g., hexahydrophthalic anhydride, triethylenetetramine, dimethylaminopropylamine, diethylaminopropylamine, propylenediamine, polyethylene glycol, polypropylene glycol and trimethylolpropane).

For each copolymer of the present invention, a process for preparing the copolymer is provided. The process comprises ring-opening polymerizing glycolide in a molten state, and extruding and granulating the resulting polyglycolide. The polyglycolide copolymer may be extruded and granulated with an additive selected from the group consisting of E, F and a combination thereof. The process may further comprise feeding the polyglycolide into an extruder, into which the E and the F are added.

The ring-opening polymerization of glycolide may be a three-stage reaction.

In the first stage, glycolide may be reacted with a ring-opening polymerization catalyst at a temperature of about 60-180° C., preferably about 80-160° C., for no more than about 150 minutes, preferably not more than about 120 minutes. The glycolide may be mixed with the catalyst uniformly. This first stage may be carried out in a reactor.

The ring-opening polymerization catalyst may be a metal catalyst or a non-metal catalyst. The catalyst may be selected from the group consisting of a rare earth element, a rare earth element oxide, a metal magnesium compound, an alkali metal chelate compound (e.g., tin, antimony, or titanium), a metal ruthenium and a combination thereof. The catalyst may be about 0.01-5 wt %, preferably about 0.1-5 wt %, more preferably about 1-3 wt %, of the glycolide.

In the second stage, the mixture from the first stage may be maintained at a temperature of about 100-200° C., preferably about 120-280° C., for a time from about 0.1 minute to about 90 hours, preferably from about 1 minute to about 72 hours. This second stage may be carried out in a plug flow reactor. The plug flow reactor may be a static mixer, a twin-screw unit, or a horizontal disk reactor. Where the plug flow reactor is a twin-screw unit, the second stage may be carried out at about 200-300° C., preferably about 230-280° C., more preferably about 240-270° C.

In the third stage, the mixture from the second stage may be maintained at a temperature of about 150-300° C., preferably about 160-280° C., and an absolute pressure no more than about 6,000, preferably no more than about 5,000 Pa, for a time from about 0.1 minute to about 36 hours, preferably from about 1 minute to about 24 hours. As a result, a polyglycolide is prepared. The third stage may be carried out in a devolatilization reactor.

The copolymer of the present invention may comprise an additive at about 0.01-5 wt %, preferably about 0.01-3 wt %, more preferably about 0.01-1 wt %, based on the total weight of the copolymer. The additive may be selected from the group consisting of E, F and a combination thereof.

The copolymer may have a weight-average molecular weight of 10,000-1,000,000. The copolymer may have a ratio of a weight-average molecular weight to a number-average molecular weight (Mw/Mn) of about 1.0-4.0, preferably about 1.1-3.0, more preferably about 1.2-2.5

The copolymer may have a melt index (MFR) of about 0.1-1000 g/10 min, preferably about 0.15-500 g/10 min, more preferably about 0.2-100 g/10 min. The MFR of a copolymer may be determined using a MFR method. The MFR method comprises drying the copolymer under vacuum at about 100-110° C. (e.g., about 105° C.); packing the dried copolymer into a rod; keeping the rod at a temperature of about 220-240° C. (e.g., about 230° C.), for about 0.5-1.5 minutes (e.g., about 1.0 minute); cutting a segment from the rod about every 15-45 seconds (e.g., about every 30 seconds); and determining a MFR of each segment based on MFR=600 W/t(g/10 min). W is the average mass of each segment. t is the cutting time gap for each segment. About 3-5 g (e.g., 4 g) of the dried copolymer may be loaded into a barrel, a plunger may be inserted into the barrel to compact the dried copolymer into the rod, and a weight of 2-3 kg (e.g., 2.16 kg) may be placed on the top of the plunger.

The copolymer may further comprise a colorant at about 0.001-30.000 wt %, preferably about 1-10 wt %, more preferably about 0-1 wt %. The colorant may be an inorganic compound, an organic compound, or a combination thereof. The colorant may be a pigment, a dye or a combination thereof. The pigment may be selected from the group consisting of an inorganic pigment, a phthalocyanine pigment, a heterocyclic and anthraniloid pigment, an oxonium lake pigment, a triarylmethane pigment, a triarylmethane lake pigment, a nitro pigment, a nitroso pigment, an imine pigment, a methylimine metal complex pigment, a fluorescent pigment, a monoazo pigment, a disazo pigment, a benzimidazolone pigment, a bisacetylacetoacetylamine pigment, an isoporphyrin pigment, a quinoxalinedione pigment, a diamine pigment, a quinone pyrimidine pigment, a titanium oxide, a titanium salt, an iron oxide, an iron salt, a molybdenum oxide, a molybdenum salt and a combination thereof. The dye may be selected from the group consisting of an acid dye, an ice dye, a cationic dye, a direct dye, a disperse dye, a reactive dye, a sulfur dye, a vat dye, a solvent dye and a combination thereof.

The colorant may comprise a yellow colorant. The yellow colorant may be selected from the group consist of P.Y.129, C.I. Pigment Yellow 7, C.I. Pigment Yellow 12, C.I. Pigment Yellow 13, C.I. Pigment Yellow 14, C.I. Pigment Yellow 17, C.I. Pigment Yellow 93, C.I. Pigment Yellow 120, C.I. Pigment Yellow 128, C.I. Pigment Yellow 138, C.I. Pigment Yellow 139, C.I. Pigment Yellow 151, C.I. Pigment Yellow 154, C.I. Pigment Yellow 155, C.I. Pigment Yellow 174, C.I. Pigment Yellow 180, C.I. Pigment Yellow 185, C.I. Pigment Yellow 194, C.I. Pigment Yellow 194, C.I. Pigment Yellow 198, C.I. Pigment Yellow 213, C.I. Pigment Yellow 214, C.I. Pigment Yellow 217, Solvent Yellow 33, Solvent Yellow 43, Solvent Yellow 44, Solvent Yellow 85, Solvent Yellow 98, Solvent Yellow 104, Solvent Yellow 116, Solvent Yellow 131, Solvent Yellow 135, Solvent Yellow 145, Solvent Yellow 160:1, Solvent Yellow 172, C.I. coumarin 6, P.Y.129 and Basic Yellow. The colorant may further comprise another colorant such as a red colorant, green colorant, an orange colorant or a combination thereof.

In one embodiment, the copolymer comprises 0.001-30 wt %, 0.01-20 wt % or 0.1-1 wt % of the yellow colorant, based on the total weight of the copolymer.

The term “yellowness index” used herein refers to a number calculated from spectrophotometric data that describes the change in color of a test sample from clear or white to yellow. Test method may be ASTM E313. The term “yellowness index change rate” used herein refers to the relative change in the yellow index after aging as compared with that before aging, ΔYI=(YI after aging−YI before aging)*100%/YI before aging).

The copolymer may have a yellowness index (YI) of about 40-90, about 50-80 or about 55-75 when measured using a sheet obtained by compression molding and crystallization of the copolymer. The copolymer may have a yellowness index change rate (ΔYI=(YI after aging−YI before aging)*100%/YI before aging) is less than about 400%, 300%, 200%, 100%, 90%, 80%, 70%, 60%, 50%, 40%, 30%, 20% or 10% after heat aging at 100-200° C. or about 140-160° C. (e.g., about 150° C.) for about 48-96 hours or about 70-75 hours (e.g., about 72 hours).

A method for reducing yellowness index change rate of a polyglycolide copolymer is provided. The method comprises adding an effective amount of a yellow colorant into the polyglycolide copolymer. The yellowness index change rate may be reduced by at least about 10%, 20%, 30%, 40%, 50%, 60%, 70%, 80%, 90% or 95%, for example, over a period of about 1, 2, 3, 4, 5, 6, 7, 8, 9 or 10 days. The polyglycolide copolymer may be one of the copolymers of the invention.

The term “about” as used herein when referring to a measurable value such as an amount, a percentage, and the like, is meant to encompass variations of +20% or +10%, more preferably +5%, even more preferably +1%, and still more preferably +0.1% from the specified value, as such variations are appropriate.

### Example 1. Polymers

### 1. Polymer 1

Glycolide and ring-opening polymerization catalyst tin dichloride dihydrate in an amount of 0.01 part by weight relative to the weight of the glycolide are mixed uniformly in a prefabricated tank reactor at 120° C. for 60 min.

The material in the prefabricated tank reactor is introduced into a polymerization reactor and reacted at 200° C. for 300 min under an absolute pressure of 0.1 MPa. The polymerization reactor is a plug flow reactor, which may be a static mixer, a twin-screw unit or a horizontal disk reaction.

The material in the polymerization reactor is introduced into an optimization reactor at a mixing speed of 200 RPM at 220° C., an absolute pressure of 50 Pa. The reaction time is 30 min. As a result, polyglycolide is prepared.

### 2. Polymer 2

Polymer 2 was prepared according to the preparation process described for Polymer 1 except that ring-opening polymerization catalyst tin dichloride dihydrate was in an amount of 0.05 part by weight relative to the weight of the glycolide.

### Example 2. Characterization

### 1. Weight-Average Molecular Weight and its Distribution

A sample is dissolved in a solution of five mmol/L sodium trifluoroacetate in hexafluoroisopropanol to prepare a solution of 0.05-0.3 wt % (mass fraction). The solution is then filtered with a 0.4 μm pore size polytetrafluoroethylene filter. 20 μL of the filtered solution is added to the Gel Permeation Chromatography (GPC) injector for determination of molecular weight of the sample. Five standard molecular weights of methyl methacrylate with different molecular weights are used for molecular weight correction.

### 2. Tensile Strength Test

The tensile strength is tested according to GB/T1040 1-2006 and the tensile speed is 50 mm/min.

### 3. Melt Index (MFR) Test

The melt index (MFR) of a copolymer is tested according to the following method: 1) drying the copolymer in a vacuum drying oven at 105° C.; 2) setting the test temperature of the test instrument to 230° C. and preheating the instrument; 3) loading 4 g of the dried copolymer into a barrel through a funnel and inserting a plunger into the barrel to compact the dried copolymer into a rod; 4) keeping the dried copolymer in the rod for 1 min with a weight of 2.16 kg pressing on top of the rod, and then cutting a segment every 30 s to obtain a total of five segments; 5) weighing the mass of each sample and calculating its MFR. MFR=600 W/t (g/10 min), where W is the average mass per segment of the sample and t is the cutting time gap for each segment.

### 4. Yellowness Index YI Test

A copolymer having a smooth surface and no obvious convexity was selected. The yellowness index (YI) of the product was determined by using NS series color measuring instrument of 3nh company. According to ASTM E313, the measurement was carried out three times under the conditions of 10 degree observation angle, D65 observation light source and reflected light measurement, and the average value was calculated to determine the yellowness index (YI) of the copolymer.

### 5. Aging Test

The following measurements were determined after placing a copolymer in an oven at 150° C. for 72 hours:

(1) Yellowness index change rate ΔYI=(YI₂—YI₁)/YI₁*100%, where YI₁ is the initial yellowness index and YI₂ is the yellowness index after aging and

(2) Melt index change rate ΔMFR=MFR′-MFR, where MFR is the initial melt index and MFR′ is the melt index after aging.

### Example 3. Copolymers 1-6

A polyglycolide (PGA) and Copolymers 1-6 were prepared with Polymer 1 as described in Example 1 and one or more additives, and then characterized according to the methods described in Example 2. Table 1 shows the compositions and properties of these copolymers.

PGA 1 was prepared with Polymer 1 and 0.06 wt % of the antioxidant Irganox 168, based on the total weight of the copolymer, were placed in a twin-screw extruder for granulation into particles at an extrusion temperature of 250° C. The particles were dried at 120° C. for 4 hours and molded into stripes for testing using an injection-molding machine at an injection temperature of 250° C. and a molding temperature of 100° C. The testing results are shown in Table 1.

Copolymer 1 was prepared according to the process used to make PGA 1 except that 0.06 wt % of the metal passivator Chel-180, based on the total weight of the copolymer, was further added. The test results are shown in Table 1.

Copolymer 2 was prepared according to the process used to make PGA 1 except that 0.2 wt % of the structural regulator ADR4368, based on the total weight of the copolymer, was further added. The test results are shown in Table 1.

Copolymer 3 was prepared according to the process used to make PGA 1 except that additives 0.06 wt % of the metal passivator Chel-180 and 0.2 wt % of the structural regulator ADR4368, based on the total weight of the copolymer, was further added. The test results are shown in Table 1.

Copolymer 4 was prepared according to the process used to make PGA 1 except that additives 0.06 wt % of the metal passivator Chel-180, 0.2 wt % of the structural regulator ADR4368 and 1 wt % of C.I. Pigment Yellow 180, based on the total weight of the copolymer, was further added. The test results are shown in Table 1.

Copolymer 5 was prepared according to the process used to make PGA 1 except that additives 0.06 wt % of the metal passivator Chel-180, 0.2 wt % of the structural regulator ADR4368 and 1 wt % of the Solvent Yellow 160:1, based on the total weight of the copolymer, was further added. The test results are shown in Table 1.

Copolymer 6 was prepared according to the process used to make PGA 1 except that 0.08 wt % of the metal passivator Chel-180, 0.2 wt % of the structural regulator ADR4368 and 10 wt % of P.Y.129, based on the total weight of the copolymer, was further added. The test results are shown in Table 1.

TABLE 1
Synthesis Parameters and Performance Results for Copolymers 1-6

| | | | Copolymer | Copolymer | Copolymer | Copolymer | Copolymer | Copolymer |
|---|---|---|---|---|---|---|---|---|
| | Unit | PGA 1 | 1 | 2 | 3 | 4 | 5 | 6 |
| Polymer 1 | % | 99.94 | 99.88 | 99.74 | 99.68 | 98.68 | 98.68 | 89.66 |
| Irganox 168 | % | 0.06 | 0.06 | 0.06 | 0.06 | 0.06 | 0.06 | 0.06 |
| C.I. | % | | | | | 1 | | |
| Pigment | | | | | | | | |
| Yellow 180 | | | | | | | | |
| Solvent | % | | | | | | 1 | |
| Yellow | | | | | | | | |
| 160:1 | | | | | | | | |
| P.Y.129 | % | | | | | | | 10 |
| Chel-180 | % | | 0.06 | | 0.06 | 0.06 | 0.06 | 0.08 |
| ADR4368 | % | | | 0.2 | 0.2 | 0.2 | 0.2 | 0.2 |
| Mw | g/mol | 122000 | 148000 | 161000 | 169800 | 169900 | 169500 | 170000 |
| MFR | g/10 min | 37 | 24 | 18 | 9 | 11 | 11 | 10 |
| MFR′ | g/10 min | 160 | 124 | 119 | 95 | 101 | 102 | 110 |
| ^{Δ}MFR | % | 123 | 100 | 101 | 86 | 90 | 91 | 100 |
| Tensile | MPa | 5799 | 6077 | 6089 | 6187 | 6099 | 6199 | 6201 |
| modulus | | | | | | | | |
| Tensile | MPa | 112 | 113 | 114 | 118 | 112 | 115 | 118 |
| stress | | | | | | | | |
| Tensile | % | 17.4 | 16 | 15.3 | 15.1 | 17.4 | 13.1 | 13.3 |
| enlongation | | | | | | | | |
| YI | | 21 | 25 | 27 | 26 | 60 | 55 | 72 |
| ^{Δ}YI | % | 320% | 251% | 233% | 210% | 51% | 62% | 22% |

As shown in Table 1, PGA 1, without ADR4368 and Chel-180, showed higher MFR, ΔMFR, ΔYI values, while Copolymers 1-3, with ADR4368 and Chel-180 added, showed reduced MFR, ΔMFR, ΔYI values, and slightly increased tensile modulus, which contributes to the maintenance of performance after aging and reflects the good thermal stability.

Comparing to Copolymer 3, addition of yellow pigments into Copolymers 4-6 increased YI value and decreased the ΔYI value, while the melt index MFR and the tensile modulus did not change significantly. This shows that the copolymer has small color change after aging and can maintain certain mechanical properties and thermal stability, which embodies the advantages of the invention.

### Example 3. Copolymers 7-11

PGA and Copolymers 7-11 were prepared with Polymer 2 as described in Example 1 and one or more additives, and then characterized according to the methods described in Example 2. Table 2 shows the compositions and properties of these copolymers.

PGA 2 was prepared with the Polymer 2 and 0.06 wt % of the antioxidant Irganox 168, based on the total weight of the copolymer, were placed in a twin-screw extruder for granulation into particles at an extrusion temperature of 250° C. The particles were dried at 120° C. for 4 hours and molded into stripes for testing using an injection-molding machine at an injection temperature of 250° C. and a molding temperature of 100° C. The testing results are shown in Table 2.

Copolymer 7 was prepared according to the process used to make PGA 2 except that 0.06 wt % of the metal passivator Chel-180, based on the total weight of the copolymer, was further added. The test results are shown in Table 2.

Copolymer 8 was prepared according to the process used to make PGA 2 except that 0.2 wt % of the structural regulator ADR4368, based on the total weight of the copolymer, was further added. The test results are shown in Table 2.

Copolymer 9 was prepared according to the process used to make PGA 2 except that additives 0.06 wt % of the metal passivator Chel-180 and 0.2 wt % of the structural regulator ADR4368, based on the total weight of the copolymer, was further added. The test results are shown in Table 2.

Copolymer 10 was prepared according to the process used to make PGA 2 except that additives 0.06 wt % of the metal passivator Chel-180, 0.2 wt % of the structural regulator ADR4368 and 1 wt % of C.I. Pigment Yellow 180, based on the total weight of the copolymer, was further added. The test results are shown in Table 2.

Copolymer 11 was prepared according to the process used to make PGA 2 except that additives 0.06 wt % of the metal passivator Chel-180 and 0.2 wt % of the structural regulator ADR4368 and 1 wt % of the Solvent Yellow 160:1, based on the total weight of the copolymer, was further added. The test results are shown in Table 2.

TABLE 2
Synthesis Parameters and Performance Results for Copolymers 7-11

| | | | Copolymer | Copolymer | Copolymer | Copolymer | Copolymer |
|---|---|---|---|---|---|---|---|
| | Unit | PGA 2 | 7 | 8 | 9 | 10 | 11 |
| Polymer 2 | % | 99.94 | 99.88 | 99.74 | 99.68 | 98.68 | 98.68 |
| Irganox | % | 0.06 | 0.06 | 0.06 | 0.06 | 0.06 | 0.06 |
| 168 | | | | | | | |
| C.I. | % | | | | | 1 | |
| Pigment | | | | | | | |
| Yellow 180 | | | | | | | |
| Solvent | % | | | | | | 1 |
| Yellow | | | | | | | |
| 160:1 | | | | | | | |
| Chel-180 | % | | 0.06 | | 0.06 | 0.06 | 0.06 |
| ADR4368 | % | | | 0.2 | 0.2 | 0.2 | 0.2 |
| Mw | g/mol | 128000 | 145900 | 161000 | 171000 | 170000 | 169000 |
| MFR | g/10 min | 33 | 28 | 20 | 11 | 11 | 10 |
| MFR′ | g/10 min | 151 | 129 | 121 | 103 | 104 | 102 |
| ^{Δ}MFR | % | 118 | 101 | 101 | 92 | 93 | 92 |
| Tensile | MPa | 5799 | 6077 | 6089 | 6187 | 6163 | 6199 |
| modulus | | | | | | | |
| Tensile | MPa | 112 | 113 | 114 | 118 | 112 | 115 |
| stress | | | | | | | |
| Tensile | % | 17.4 | 16 | 15.3 | 15.1 | 17.4 | 13.1 |
| elongation | | | | | | | |
| YI | | 60 | 57 | 59 | 56 | 71 | 73 |
| ^{Δ}YI | % | 48% | 36% | 39% | 32% | 26% | 23% |

Compared with PGA 1, increased content of the polymerization catalyst in PGA 2 reduced the ΔYI value, indicating smaller change in color value after aging. Compared with PGA 2, structural modifier ADR4368 and metal passivator Chel-180 in Copolymers 7-9 helped reducing both ΔMFR and ΔYI, indicating better maintenance of the performance of the copolymers after aging. Comparing to Copolymer 9, adding yellow pigments to Copolymers 10 and 11 increased the YI value and decreased the ΔYI value, while the changes of melt index MFR and tensile modulus were not obvious, indicating that the addition of yellow pigments can reduce the yellowness index, but has little effect on the performance after aging. This reflects the advantages of the invention.

Although the invention is illustrated and described herein with reference to specific embodiments, the invention is not intended to be limited to the details shown. Rather, various modifications may be made in the details within the scope and range of equivalents of the claims without departing from the invention.

1. A copolymer comprising one or more repeating units of C-(Aₓ-B_{y})ₙ-D and a colorant, wherein:
A is 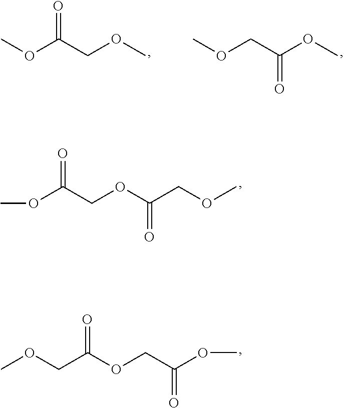
or a combination thereof;
B is G-R₁—W;
G and W are each selected from the group consisting of —CO—NH—, —CO—R₂—CO—OH, —CO—, —(CH₂)₂NH—CO—, —CH₂—CH(OH)—CH₂— and —NH;
R₁ is an aliphatic polymer, an aromatic polymer or a combination thereof;
R₂ is an alkyl group, an aromatic group, or an olefin group;
x is between 1 and 1500;
y is between 1 and 1500;
n is between 1 and 10000;
C and D are each a terminal group selected from the group consisting of a hydroxyl group, a carboxyl group, an amine group, an alkyl group, an aromatic group, an ether group, an alkene group, a halogenated hydrocarbon group and a combination thereof; and
A and B are different in structure.

2. The copolymer of claim 1, further comprising an additive selected from the group consisting of E, F and a combination thereof,
wherein E is one or more of units of i-R₁-j, i and j are each selected from the group consisting of an isocyanate group (—N═C═O), an acid chloride group, an oxazolyl group, an oxazoline group, an anhydride, an epoxy group, an amine group and a combination thereof; and R₁ is an aliphatic group, an aromatic group, or a combination thereof; and wherein F is selected from the group consisting of an antioxidant, a metal passivator, an end-capping agent, a nucleating agent, an acid scavenger, a heat stabilizer, a UV stabilizer, a lubricant plasticizer, a crosslinking agent, and a combination thereof.

3. A process for preparing a copolymer, comprising
(a) ring-opening polymerizing glycolide in a molten state, whereby a polyglycolide is formed; and
(b) extruding and granulating the polyglycolide and a colorant, whereby a copolymer is prepared, wherein the copolymer comprises one or more repeating units of C-(Aₓ-B_{y})ₙ-D and the colorant:
A is 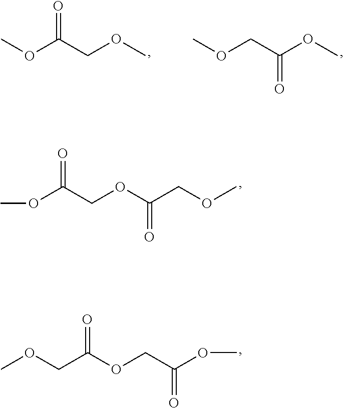
or a combination thereof;
B is G-R₁—W;
G and W are each selected from the group consisting of —CO—NH—, —CO—R₂—CO—OH, —CO—, —(CH₂)₂NH—CO—, —CH₂—CH(OH)—CH₂— and —NH;
R₁ is an aliphatic polymer, an aromatic polymer or a combination thereof;
R₂ is an alkyl group, an aromatic group, or an olefin group;
x is between 1 and 1,500;
y is between 1 and 1,500;
n is between 1 and 10,000;
C and D are each a terminal group selected from the group consisting of a hydroxyl group, a carboxyl group, an amine group, an alkyl group, an aromatic group, an ether group, an alkene group, a halogenated hydrocarbon group and a combination thereof;
A and B are different in structure.

4. The process of claim 3, wherein the polyglycolide and the colorant are extruded and granulated with an additive selected from the group consisting of E, F or a combination thereof,
wherein E is one or more of units of i-R₁-j; i and j are each selected from the group consisting of an isocyanate group (—N═C═O), an acid chloride group, an oxazolyl group, an oxazoline group, an anhydride, an epoxy group, an amine group and a combination thereof; and R₁ is an aliphatic group, an aromatic group, or a combination thereof; and
F is selected from the group consisting of an antioxidant, a metal passivator, an end-capping agent, a nucleating agent, an acid scavenger, a heat stabilizer, a UV stabilizer, a lubricant plasticizer, a crosslinking agent, and a combination thereof.

5. The process of claim 4, further comprising feeding the polyglycolide into an extruder, and adding the colorant and the additive into the extruder.

6. The process of claim 3, wherein step (a) is a three-stage reaction comprising:
(a) reacting the glycolide with a ring-opening polymerization catalyst at 80-160° C. for no more than 120 minutes, wherein a first mixture is formed;
(b) maintaining the first mixture at 120-280° C. for a time from 1 minute to 72 hours, whereby a second mixture is formed;
(c) maintaining the second mixture at 160-280° C. and an absolute pressure no more than 5000 Pa for a time from 1 minute to 24 hours, whereby the polyglycolide is formed.

7. The process of claim 6, wherein the ring-opening polymerization catalyst is a metal catalyst.

8. The process of claim 6, wherein the ring-opening polymerization catalyst is a non-metal catalyst.

9. The process of claim 6, wherein the ring-opening polymerization catalyst is selected from the group consisting of a rare earth element, a rare earth element oxide, a metal magnesium compound, an alkali metal chelate compound, a metal ruthenium and a combination thereof.

10. The process of claim 6, wherein the catalyst is 0.01-5 wt % of the glycolide.

11. The process of claim 6, wherein step (a) further comprising mixing the glycolide with the ring-opening polymerization catalyst uniformly.

12. The process of claim 6, wherein step (a) is carried out in a reactor.

13. The process of claim 6, wherein step (b) is carried out in a plug flow reactor.

14. The process of claim 13, wherein the plug flow reactor is selected from the group consisting of a static mixer, a twin-screw unit and a horizontal disk reactor.

15. The process of claim 6, wherein step (c) is carried out in a devolatilization reactor.

16. The process of claim 3, wherein step (b) is carried out in a twin-screw extruder at 200-300° C.

17. A copolymer prepared according to the process of claim 3.

18. The copolymer of claim 2, wherein the copolymer comprises the additive at 0.01-5 wt %, based on the total weight of the copolymer.

19. The copolymer of claim 1, wherein the copolymer has a weight-average molecular weight of 10,000-1,000,000.

20. The copolymer of claim 1, wherein the copolymer has a ratio of a weight-average molecular weight to a number-average molecular weight (Mw/Mn) of 1.0-4.0.

21. The copolymer of claim 1, wherein the copolymer has a melt index (MFR) of 0.1-1000 g/10 min.

22. The copolymer of claim 21, wherein the melt index (MFR) is determined according to a method comprising:
(a) drying the copolymer under vacuum at 100-110° C.;
(b) packing the dried copolymer from step (a) into a rod;
(c) keeping the rod at 220-240° C. for 0.5-1.5 minutes;
(d) cutting a segment from the rod every 15-45 seconds after step (c); and
(e) determining a MFR of each segment based on MFR=600 W/t(g/10 min), wherein W is the average mass of each segment and t is the cutting time gap for each segment.

23. The copolymer of claim 22, wherein step (b) further comprises loading 3-5 g of the dried copolymer into a barrel, inserting a plunger into the barrel to compact the dried copolymer into the rod, and placing a weight of 2-3 kg on the top of the plunger.

24. The copolymer of claim 1, wherein the copolymer comprises the colorant at 0.001-30.000 wt %.

25. The copolymer of claim 1, wherein the colorant is an inorganic compound, an organic compound, or a combination thereof.

26. The copolymer of claim 1, wherein the colorant may be a pigment, a dye or a combination thereof.

27. The copolymer of claim 26, wherein the pigment is selected from the group consisting of an inorganic pigment, a phthalocyanine pigment, a heterocyclic and anthraniloid pigment, an oxonium lake pigment, a triarylmethane pigment, a triarylmethane lake pigment, a nitro pigment, a nitroso pigment, an imine pigment, a methylimine metal complex pigment, a fluorescent pigment, a monoazo pigment, a disazo pigment, a benzimidazolone pigment, a bisacetylacetoacetylamine pigment, an isoporphyrin pigment, a quinoxalinedione pigment, a diamine pigment, a quinone pyrimidine pigment, a titanium oxide, a titanium salt, an iron oxide, an iron salt, a molybdenum oxide, a molybdenum salt and a combination thereof.

28. The copolymer of claim 26, wherein the dye is selected from the group consisting of an acid dye, an ice dye, a cationic dye, a direct dye, a disperse dye, a reactive dye, a sulfur dye, a vat dye, a solvent dye and a combination thereof.

29. The copolymer of claim 1, the colorant comprises a yellow colorant.

30. The copolymer of claim 29, the yellow colorant is selected from the group consisting of P.Y.129, C.I. Pigment Yellow 7, C.I. Pigment Yellow 12, C.I. Pigment Yellow 13, C.I. Pigment Yellow 14, C.I. Pigment Yellow 17, C.I. Pigment Yellow 93, C.I. Pigment Yellow 120, C.I. Pigment Yellow 128, C.I. Pigment Yellow 138, C.I. Pigment Yellow 139, C.I. Pigment Yellow 151, C.I. Pigment Yellow 154, C.I. Pigment Yellow 155, C.I. Pigment Yellow 174, C.I. Pigment Yellow 180, C.I. Pigment Yellow 185, C.I. Pigment Yellow 194, C.I. Pigment Yellow 1-94196, C.I. Pigment Yellow 198, C.I. Pigment Yellow 213, C.I. Pigment Yellow 214, C.I. Pigment Yellow 217, Solvent Yellow 33, Solvent Yellow 43, Solvent Yellow 44, Solvent Yellow 85, Solvent Yellow 98, Solvent Yellow 104, Solvent Yellow 116, Solvent Yellow 131, Solvent Yellow 135, Solvent Yellow 145, Solvent Yellow 160:1, Solvent Yellow 172, C.I. coumarin 6, P.Y.129 and Basic Yellow.

31. The copolymer of claim 29, wherein the colorant further comprises a red colorant, green colorant, an orange colorant or a combination thereof.

32. The copolymer of claim 1, wherein the copolymer has a yellowness index (YI) of 40-90 when measured using a sheet obtained by compression molding and crystallization of the copolymer.

33. The copolymer of claim 1, wherein the copolymer has a yellowness index change rate less than 300 after being stored at 140-160° C. for 70-75 hours.

34. The copolymer of claim 1, wherein the copolymer comprises a metal passivator no more than 1% of the copolymer.

35. The copolymer of claim 2, wherein the metal passivator is selected from the group consisting of an oxalate derivative, an anthraquinone compound, a salicylic acid derivative, a benzotriazole compound, and an anthraquinone compound.

36. A method for reducing yellowness index change rate of a polyglycolide copolymer, comprising adding an effective amount of a yellow colorant into the polyglycolide copolymer.

37. The method of claim 36, wherein the copolymer has a yellowness index change rate reduced by at least 10, 20, 30, 40, 50, 60, 70, 80, 90 or 95%.

38. The method of claim 36, wherein the polyglycolide copolymer is the copolymer of claim 1.
